(19) United States
(12) Patent Application Publication
(10) Pub. No.: US 2026/0066738 A1
(43) Pub. Date: Mar. 5, 2026

(54) THREE BEARING ARRANGEMENT FOR ELECTRIC AXLE ROTOR SHAFT

(71) Applicant: Schaeffler Technologies AG & Co. KG, Herzogenaurach (DE)

(72) Inventors: Scott Angel, Marshallville, OH (US); Joshuah Fisher, Canton, OH (US); Gregory Heeke, Wooster, OH (US)

(73) Assignee: Schaeffler Technologies AG & Co. KG, Herzogenaurach (DE)

(21) Appl. No.: 18/816,242

(22) Filed: Aug. 27, 2024

(51) Int. Cl. H02K 5/173; B60K 7/00

(52) U.S. Cl. CPC H02K 5/1732; B60K 2007/0092

(57) ABSTRACT

An electric axle with an electric motor having a rotor supported by only three bearings. The electric axle includes a housing in which the electric motor is supported. The electric motor includes a rotor having a rotor body and an output shaft. A first bearing supports the rotor body in the housing, a second bearing supports an end of the output shaft in the housing, and a single intermediate bearing supports the rotor at a position between the first and second bearings.

### TECHNICAL FIELD

The present disclosure relates generally to an electric axle, and more specifically to a bearing arrangement for an electric axle rotor shaft.

### BACKGROUND

In general, electric axles (eAxles) are known structures used in electric vehicles. Electric axles typically include an electric motor and power transmission components for transmitting torque from the electric motor to the wheels of the vehicle. The power transmission components can include one or more gear stages and a differential coupled to respective axle half-shafts.

It is generally known that e-Axles utilize a series/system of rotating shafts in order to transmit torque from the electric motor to the axle half-shafts. These shafts need bearings in order to allow rotation and proper centering between the gear meshes of the various components. The rotor for the E-motor also needs to be centered about one of these shafts. Conventional eAxles use four bearings to support the axial and radial loads generated by the rotor shaft of the electric motor and the pinion gear of a gear stage or differential, for example. Each shaft is supported by two bearings, and a splined connection between the shafts allows for axial movement between the shafts.

### SUMMARY

Embodiments according to this disclosure provide an eAxle assembly having a rotor shaft and pinion gear supported by three bearings thereby decreasing costs and increasing efficiency.

In accordance with one aspect of the present disclosure, an electric axle comprises a housing, an electric motor having a rotor including a rotor body and an output shaft, a first bearing supporting the rotor body in the housing, a second bearing supporting an end of the output shaft in the housing, and an intermediate bearing fixed to the housing supporting the rotor at a position between the first and second bearings. Only the intermediate bearing is fixed against movement relative to the housing.

The first bearing can be supported in the housing for limited axial movement. A wave washer can be adjacent the first bearing. The second bearing can be supported in the housing for limited axial movement. A shim can be adjacent the second bearing. At least one of the first or second bearings can be located to the housing with at least one pin received in a slotted hole. The intermediate bearing can be fixed in the housing with a snap ring. The electric axle can include a pinion gear coupled to the output shaft and a gearset driven by the pinion gear. The second bearing and the intermediate bearing can be on opposite axial sides of the pinion gear. The intermediate bearing can be larger than the first and second bearings. The second bearing can be larger than the first bearing.

In accordance with another aspect of the present disclosure, a method of supporting an electric motor in a housing of an electric axle comprises supporting a rotor body of a rotor of the electric motor at a first end with a first bearing, supporting an end of an output shaft of the rotor of the electric motor with a second bearing, and supporting the rotor at with a single intermediate bearing at a position between the first and second bearings. Only the intermediate bearing is fixed against movement relative to the housing.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of a portion of an exemplary eAxle in accordance with the present disclosure.

FIG. 2 is an end view of the eAxle showing a motor endcap.

FIG. 3 is an enlarged portion of FIG. 2.

FIG. 4 is an enlarged portion of FIG. 2.

FIG. 5 is an end view of a gearset end of the eAxle.

FIG. 6 is an enlarged view of a slotted hole.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

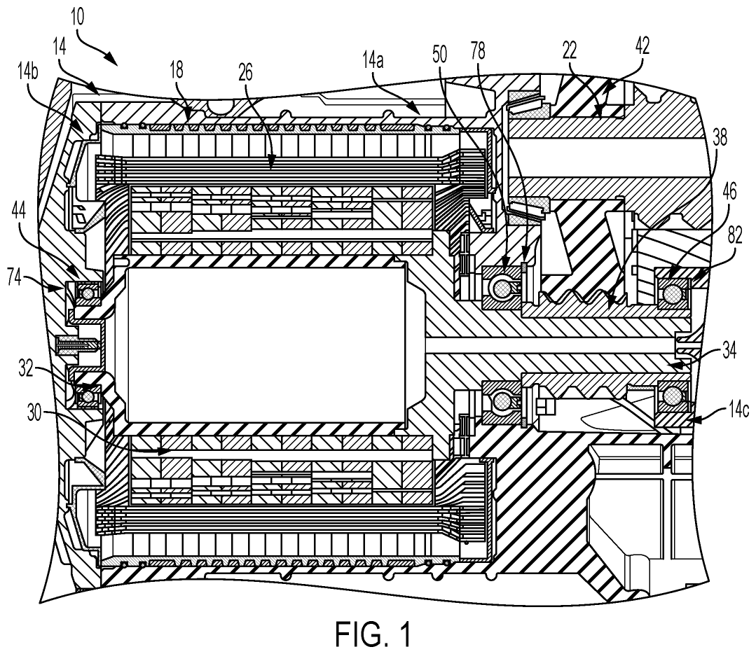

In FIG. 1, a portion of an exemplary e-Axle in accordance with the present disclosure is illustrated and identified generally by reference numeral 10. The e-Axle 10 includes a housing 14 supporting an electric motor 18 and a gearset 22. The housing 14 is comprised of a central portion 14a, a motor endcap 14b and a gearset endcap 14c. As e-Axles are known structures, it will be appreciated that the e-Axle 10 can include one or more gear reducers, multipliers, a differential, axle half shafts, etc. Aspects of the present disclosure are applicable to any e-Axle, regardless of the specific components and/or arrangement of components therein.

The electric motor 18 includes a stator 26 and a rotor 30 supported for rotation relative to the stator 26. The rotor 30 includes a rotor body 32 and an output shaft 34. A pinion gear 38 is mounted to the output shaft 34 in a rotationally fixed manner. The pinion gear 38 is meshed with a spur gear 42 for transmitting torque from the electric motor 18 to the gearset 22 and, ultimately to the wheels of a vehicle.

The rotor 30 is supported in the housing 14 at a first end by first bearing 44 supported in the motor endcap 14b and the output shaft 34 of the rotor 30 is supported by a second bearing 46 supported in the gearset endcap 14c. A third (intermediate) bearing 50 supports the output shaft 34 at an intermediate position between the first and second bearings 44 and 46. The second bearing 46 and third bearing 50 are located on opposite axial sides of the pinion gear 38.

In the illustrated embodiment, the third bearing 50 is larger than the second bearing 46, and the second bearing 46 is larger than the first bearing 44. The bearings can be rolling bearings, angular bearings, or a combination thereof. In some examples, an axial distance between the first bearing 44 and the third bearing 50 can be greater than an axial distance between the second bearing 46 and the third bearing 50.

Contrary to conventional arrangements having four fixed bearings supporting two shafts joined with a splined connection, each of the first bearing 44, second bearing 46 and intermediate bearing 50 are mounted in respective portions of the housing 14 in a manner to avoid over-constraint of the rotor 30 and output shaft 34.

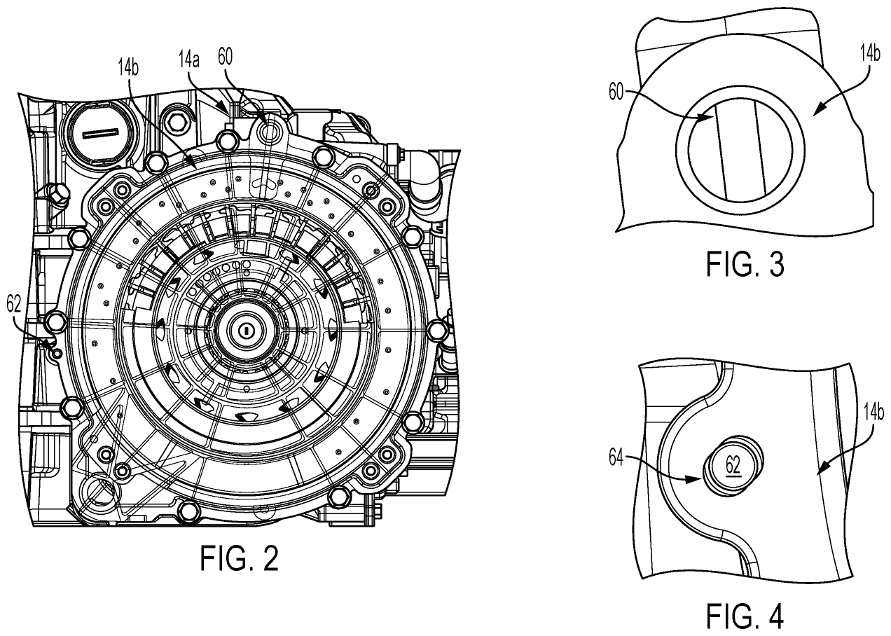

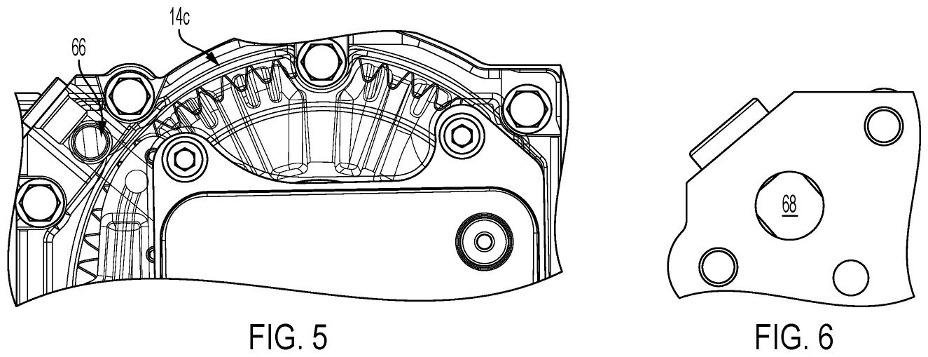

Intermediate bearing 50 is fixed within the central portion 14a of the housing 14. With additional reference to FIGS. 2-6, the motor endcap 14b supporting the first bearing 44 is located to the central portion 14a of the housing 14 with a first pin 60 and a second pin 62. The second pin 62 is received in a slotted hole 64 of the motor endcap 14b such that the motor endcap 14b can pivot a limited amount about the first pin 60. The gearset endcap 14c supporting the second bearing is located to the central portion 14a of the housing 14 with a pin 66 received in a slotted holes 68 of the gearset endcap 14c such that the second bearing 46 acts as a pin to help locate and not over-constrain the three bearing arrangement of the electric motor 18. A wave spring 74 is installed axially adjacent the first bearing 44 and permits limited axial movement of the rotor 30 and/or first bearing 44 relative to the housing 14. The intermediate bearing 50 is fixed to the housing with a snap ring 78. A shim 82 is installed adjacent the second bearing 46.

The assembly according to the present disclosure is lighter weight, more easily assembled, and more efficient that similar assemblies utilizing more than three bearings.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 e-Axle

14 housing

14a central portion

14b motor endcap

14c gearset endcap

18 electric motor

22 gearset

26 stator

30 rotor

32 rotor body

34 output shaft

38 pinion gear

42 spur gear

44 first bearing

46 second bearing

50 third bearing

60 first pin

62 second pin

64 slotted hole

66 pin

68 slotted hole

74 wave spring

78 snap ring

82 shim

What is claimed is:

1. An electric axle comprising:
a housing;
an electric motor having a rotor including a rotor body and an output shaft;
a first bearing supporting the rotor body in the housing;
a second bearing supporting an end of the output shaft in the housing; and
an intermediate bearing fixed to the housing supporting the rotor at a position between the first and second bearings;
wherein only the intermediate bearing is fixed against movement relative to the housing.

2. The electric axle according to claim 1, wherein the first bearing is supported in the housing for limited axial movement.

3. The electric axle according to claim 2, further comprising a wave washer adjacent the first bearing.

4. The electric axle according to claim 1, wherein the second bearing is supported in the housing for limited axial movement.

5. The electric axle according to claim 4, further comprising a shim adjacent the second bearing.

6. The electric axle according to claim 1, wherein at least one of the first or second bearings is located to the housing with at least one pin received in a slotted hole.

7. The electric axle according to claim 1, wherein the intermediate bearing is fixed in the housing with a snap ring.

8. The electric axle according to claim 1, further comprising a pinion gear coupled to the output shaft and a gearset driven by the pinion gear.

9. The electric axle according to claim 8, wherein the second bearing and the intermediate bearing are on opposite axial sides of the pinion gear.

10. The electric axle according to claim 1, wherein the intermediate bearing is larger than the first and second bearings.

11. The electric axle according to claim 10, wherein the second bearing is larger than the first bearing.

12. A method of supporting an electric motor in a housing of an electric axle comprising:
supporting a rotor body of a rotor of the electric motor at a first end with a first bearing;
supporting an end of an output shaft of the rotor of the electric motor with a second bearing; and
supporting the rotor at with a single intermediate bearing at a position between the first and second bearings;
wherein only the intermediate bearing is fixed against movement relative to the housing.

13. The method according to claim 12, wherein the first bearing is supported in the housing for limited axial movement.

14. The method according to claim 13, further comprising a wave washer adjacent the first bearing.

15. The method according to claim 12, wherein the second bearing is supported in the housing for limited axial movement.

16. The method according to claim 15, further comprising a shim adjacent the second bearing.

17. The method according to claim 12, wherein at least one of the first or second bearings is located to the housing with at least one pin received in a slotted hole.

18. The method according to claim 12, wherein the intermediate bearing is fixed in the housing with a snap ring.

19. The method according to claim 12, further comprising a pinion gear coupled to the output shaft and a gearset driven by the pinion gear.

20. The method according to claim 19, wherein the second bearing and the intermediate bearing are on opposite axial sides of the pinion gear.
